(19) United States
(12) Patent Application Publication
(10) Pub. No.: US 2006/0218780 A1
(43) Pub. Date: Oct. 5, 2006

(54) Automated riveting machine

(76) Inventors: Robert (nmi) Lewis, Wolverhampton (GB); Michael (nmi) Gribben, Northern Ireland (GB); Colm (nmi) McKeown, Dromara, County Down (IE); Philip (nmi) Webb, Derby (GB); Alexandru-Christian Chitiu, Nottingham (GB); Brian (nmi) Hatch, Hertfordshire (GB)

Correspondence Address: BAKER BOTTS L.L.P., 2001 ROSS AVENUE, SUITE 600, DALLAS, TX, 75201-2980, US

(21) Appl. No.: 10/537,215

(22) PCT Filed: Dec. 4, 2003
(86) PCT No.: PCT/GB03/05308

§ 371 Date: Mar. 9, 2006

(30) Foreign Application Priority Data
Dec. 4, 2002 (GB) 0228259.8

(51) Int. Cl. B21J 15/00; B23P 19/00; B23P 21/00

(52) U.S. Cl. 29/798; 901/30; 29/701; 29/34 B

(57) ABSTRACT

A tool support adapted in use to define an end deflector (20) of an automated riveting machine, com-prising at least two carrier arms (23, 24) one of which is adapted to support a riveting tool (22), in which the tool carrier arms are movable relative to a fixed datum defined by the tool support.

This invention relates to improvements in automated riveting machines. In particular, to those machines in which an end-effector is configured to achieve a rivet connection in a workpiece, to a method of achieving a rivet connection, and to a tool support adapted for use in an end-effector in an automated riveting machine.

An end-effector is a device or tool which is connected to a robot. The structure of the end-effector depends upon the task to be performed.

Riveting machines are capable of performing all the processes necessary for automated riveting of aero-structures. However, the machines are large, expensive and relatively inflexible. There are also limits to the percentage of the total rivets that can be inserted automatically, the remaining requiring manual insertion. These limits are due either to access limitations or rivet type. The high capital cost and long lead times of these machines can cause capacity bottlenecks and result in a requirement for significant manual riveting. The use of excessive manual riveting also has health and safety implications.

We are aware of U.S. Pat. No. 5,375,754 which discloses a robot mounted automated riveting machine including a drilling unit with lubricator, and a riveting unit, comprising a rivet supply unit and a squeezing rivet setter. The drilling unit and rivet setter being movable along a support console.

U.S. Pat. Nos. 5,379,508, 4,996,761, 5,231,747 and 5,611,130 disclose devices with the capacity to drill and rivet a workpiece, in which the drill and rivet tools are independently brought to the workpiece requiring accurate tool placement.

U.S. Pat. No. 5,404,633 discloses a drill quill which is coaxially mounted within a rivet driver. U.S. Pat. No. 4,762,261 discloses a computer aided riveting robot. U.S. Pat. No. 5,458,443 discloses a system that permits positioning of a drill bit in difficult locations allowing overhead and sideways drilling in addition to normal downward drilling. U.S. Pat. No. 5,586,391 discloses a method of drilling co-ordination holes in components using an end-effector carried by a precision computer controlled robot. U.S. Pat. No. 5,037,020 discloses a drilling and riveting tool including a ‘C’shaped support frame.

According to this invention an end-effector for an automated riveting machine includes a drill tool, a sealant dispensing tool and a riveting tool.

Alternatively, the end-effector of the invention may comprise at least two tools, wherein at least one of the tools is a riveting tool. The other tool, or tools, being any other suitable tool, for example, a drill, an adhesive, sealant or lubricant dispensing/applying tool, a screw driver, a screw applying tool, a nut or bolt applying tool, or a self piercing riveting device.

The end-effector may be provided with a fixed datum with respect to which the tools are movable.

The fixed datum may be configured as a guide hole. The individual tools of the end-effector may operate through the guide hole, ensuring accuracy of tool placement at a workpiece.

Preferably the end-effector includes a tool support, configured to accommodate the tools, in which the fixed datum or guide hole is located. Preferably the guide hole is located at the end of the tool support which in use is located closest to the workpiece. When the end-effector is in use the guide hole may contact the workpiece.

The use of a fixed datum within the end-effector removes the requirement for high levels of repeatability from the positioning system within the end-effector and from the positioning robot since it remains stationary throughout the riveting cycle. This approach results in a significant reduction in size, cost and complexity relative to existing systems where the individual units are positioned independently.

Preferably individual tools are movable in the end-effector between a resting position, spaced away from the guide hole, and an operating position, at the guide hole, from where each individual tool can perform its designed operation.

The tool support of the end-effector may include at least one carrier arm in which at least one tool may be accommodated. Preferably an end-effector with three tools, such as a drill, a sealant dispenser and a riveting tool, includes three carrier arms, each accommodating one of the three tools.

Preferably the carrier arm is movable relative to the guide hole or fixed datum. In an end-effector with more than one carrier arm, one or more of the carrier arms may be movable.

Preferably movement of the carrier arm will also effect movement of a tool accommodated therein. By moving the carrier arm the tool may be moved from the resting position to the operating position, or from the operating position to the resting position, or to any position there between.

A carrier arm may include one or more bores. The bores may be used to mount a carrier arm on a support member of the tool support or to accommodate a tool. Preferably, each carrier arm comprises two bores, the first bore may be used to mount the carrier arm on a support member, and the second bore may accommodate a tool.

Preferably one carrier arm is mounted on one support member, however more than one carrier arm may be mounted on one support member.

Preferably the support members, upon which carrier arms may be mounted, form part of the tool support. The support members may be configured as rigid structures. There may be more than one support member. Preferably the end-effector includes three parallel support members. The support members may fix opposing ends of the tool support of the end-effector in a fixed spaced relationship. Opposing ends of the tool support may be configured as plates. The end of the tool support which in use is located closest to the workpiece may include the guide hole or fixed datum. The guide hole may be included in an end plate. Preferably the support members are spaced around the guide hole. The support members may be located equidistant from the guide hole and equidistant from each other.

A carrier arm mounted on a support member may pivot about the support member. In an end-effector with more than one carrier arm one or more of the arms may pivot. The pivoting of a carrier arm accommodating a tool may move the tool between the resting and the operating position. That is, the tool may be moved from a resting position to the side of the guide hole to an operating position over the guide hole and back again. The pivoting of the carrier arm may result in the arcuate movement of a tool accommodated therein. Preferably a ram and cylinder assembly moves each carrier arm, this may be pneumatically operated.

Preferably, an end-effector with three tools, has three carrier arms, each accommodating a different tool, each carrier arm mounted on one of three different support members. Each carrier arm may pivot about the support member on which it is mounted to bring each tool to the guide hole in turn. Preferably each carrier arm moves in the same plane. Once a tool is located at the guide hole it may operate through the guide hole to perform its designed function.

By way of example, if a drilling tool, a sealant dispensing tool and a riveting tool are located in three carrier arms each may be sequentially positioned at the guide hole, in the operating position. Firstly, the drill may be moved to the operating position, where drilling and countersinking operations may be performed in the workpiece. Secondly, the drilling tool may be moved to a resting position and the sealant dispensing tool may be moved into the operation position where it may dispense sealant. Finally, the sealant dispensing tool may be moved to a resting position, and the riveting tool may be brought to the operating position where it may insert a rivet into the drilled hole, and then deform the rivet stem and head to complete the riveting process.

A tool support of the end-effector may also comprise a feed mechanism. Preferably the feed mechanism is adapted to extend a tool, in the operating position, into the guide hole. Once a tool is located in the guide hole it may be operated to perform its designed function. The feed mechanism may be further adapted to retract the tool from the guide hole. The feed mechanism may be adapted to capture a tool, for example, by using a movable plate adapted to capture the end of the tool distal to the guide hole. The feed mechanism may move a tool using one or more ram and cylinder assemblies. The plate may be suspended from one or more ram and cylinder assemblies, the cylinder and ram assemblies may operate to move the plate and the captured tool. Preferably the plate is configured such that when it is moved it can pass the support members and any tools located in a resting position.

Preferably the end-effector includes a load cell, such as a piezo ceramic cell, which may be located at the interface between the end-effector and the robot arm. The load cell allows the force applied by the end-effector to be accurately controlled.

Preferably the end-effector is compact comprising a cylinder of 200 mm in diameter, 400 mm in height, and an estimated weight of 40 Kg. The compact nature of the end-effector allows riveting to be performed in confined areas, thus increasing the number of rivets that can be inserted automatically.

It is envisaged that the end-effector will be able to operate with a cycle time of less than 5 seconds per rivet-allowing for time spent loading workpieces and positioning the robot. This compares with up to 20seconds for traditional automated riveting machines.

According to a second aspect of the invention an automated riveting machine comprises a first end-effector carrying the tools, and a second end-effector, the second end-effector being positioned on the opposite side of the workpiece to, and in-line with, the first end-effector.

The first end-effector may be in accordance with the first aspect of the invention.

Preferably the second end-effector comprises a clamping foot for clamping the workpiece, and/or a moveable reactor for upsetting a rivet stem.

The second end-effector may be slaved to, or synchronised with, the first end-effector, its location being determined by the location of the first end-effector.

According to a third aspect of the invention a method of achieving a rivet connection in a workpiece comprises locating a first end-effector, with at least two tools one of which is a riveting tool, at a workpiece and positioning a second end-effector at the opposite side of the workpiece in-line with the first end-effector; sequentially moving each tool, in the first end-effector, from a resting position to an operating position above a guide hole in a lower end plate of the first end-effector, and operating each tool in turn through the guide hole to perform their desired operation.

Preferably an additional tool is configured as a sealant dispensing tool and/or a drill tool.

According to a fourth aspect of the invention a tool support, adapted in use to define an end-effector of an automated riveting machine, comprises at least two tool carrier arms, one of which is adapted to support a riveting tool, in which the tool carrier arms are movable relative to a fixed datum defined by the tool support.

Preferably the fixed datum is configured as a guide hole in the tool support. Preferably the guide hole is located at the end of the tool support which in use is located closest to the workpiece, and may contact the workpiece in use.

Preferably the tool support is configured as a cage structure, in which rigid support members hold opposing ends of the tool support in a fixed spaced relationship. Preferably the support members are parallel. There may be one or more support members. There may be three support members. The support members may be spaced around the guide hole, preferably equidistant therefrom and/or from one another. Preferably the support members are located equidistant from one another. The opposing ends of the tool structure may be configured as end plates. The end plate located nearest the workpiece in use may incorporate the guide hole.

Each carrier arm of the tool support may include one or more bores. The bores may be used to mount the carrier arm on a support member or to accommodate one or more tools. Preferably each tool carrier arm is configured with two bores, the first bore being used to mount the carrier on a rigid support member, the second bore accommodating a tool. Movement of the carrier arm may allow the second bore to be positioned over the guide hole. The carrier arm may move by pivoting about the support member.

Each carrier arm may be mounted on different support members, or more than one carrier arm may be mounted on one support member. One or more carrier arms may pivot about the support member upon which it is mounted.

Preferably moving the carrier arm will move any tool accommodated in the second bore. Pivoting the carrier arm about the support arm may effect movement of a tool located in the carrier arm second bore between the resting position and the operating position. The operating position being when the second bore, which may contain a tool, is located over the guide hole.

Preferably the carrier arm is moveable by a ram and cylinder assembly. The ram and cylinder may be pneumatically operated.

A tool support of the end-effector may also comprise a feed mechanism. Preferably the feed mechanism is adapted to extend a tool, in the operating position, into the guide hole. Once a tool is located in the guide hole it may be operated to perform its designed function. The feed mechanism may be further adapted to retract the tool from the guide hole. The feed mechanism may be adapted to capture a tool, for example, by using a movable plate adapted to capture the end of the tool distal to the guide hole. The feed mechanism may move a tool using one or more ram and cylinder assemblies. The plate may be suspended from one or more ram and cylinder assemblies, the cylinder and ram assemblies may operate to move the plate and the captured tool. Preferably the plate is configured such that when it is moved is can pass the support members and any tools located in a resting position.

This nature of the design of the tool support makes it easy to use alternative tools without having to change the end-effector design.

There will now be described, by way of example only, one embodiment of the present invention with reference to the accompanying drawings of which:

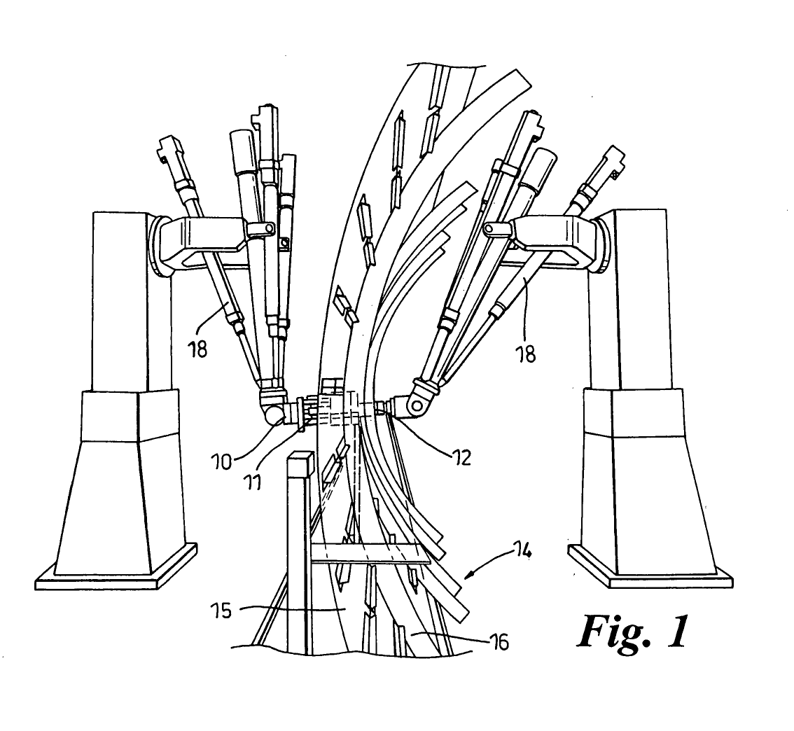

FIG. 1 is a schematic perspective view of the automated riveting machine, comprising an upper and a lower end-effector located at a workpiece;

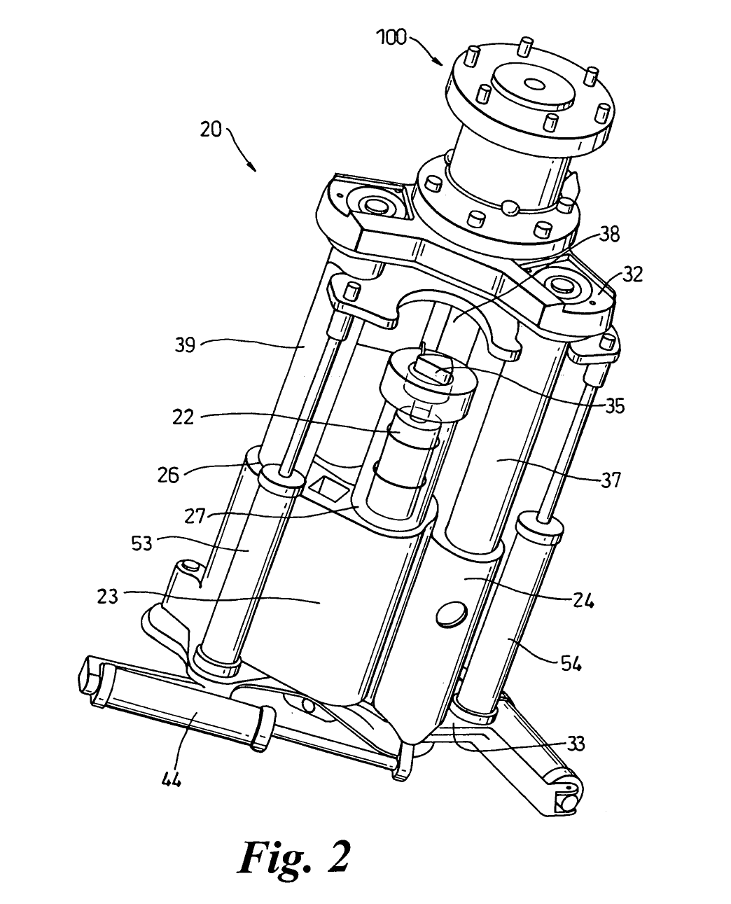

FIG. 2 is a schematic perspective view of the upper end-effector of FIG. 1;

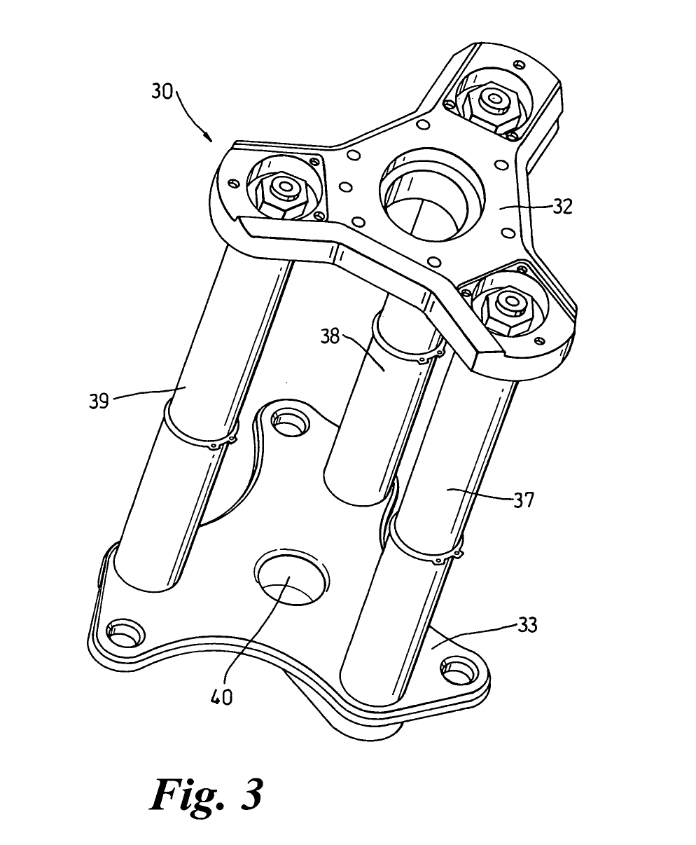

FIG. 3 is a schematic perspective view of the cage structure assembly of the end-effector of FIG. 2, in which the guide hole is clearly visible;

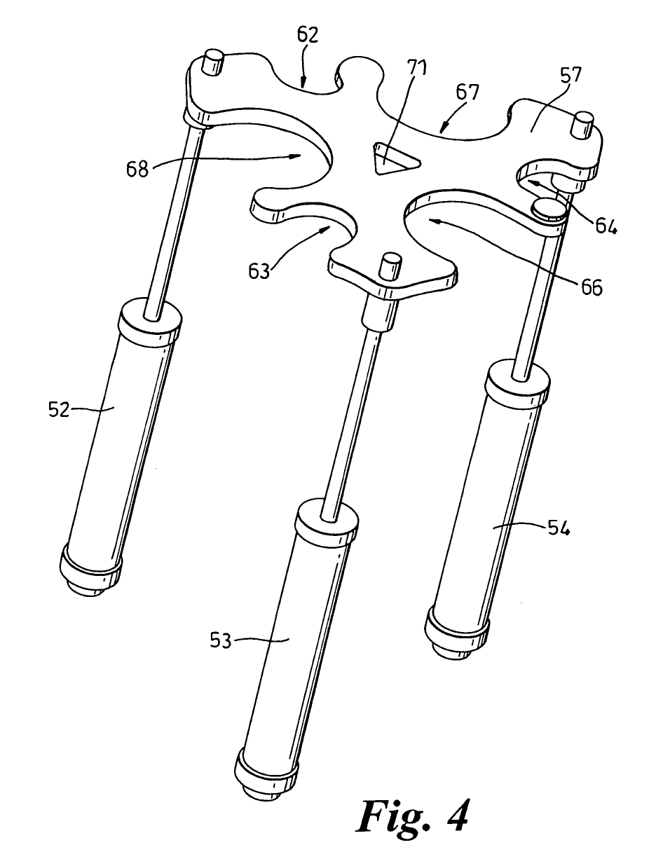

FIG. 4 is a schematic perspective view of the feed-mechanism assembly of the end-effector of FIG. 2;

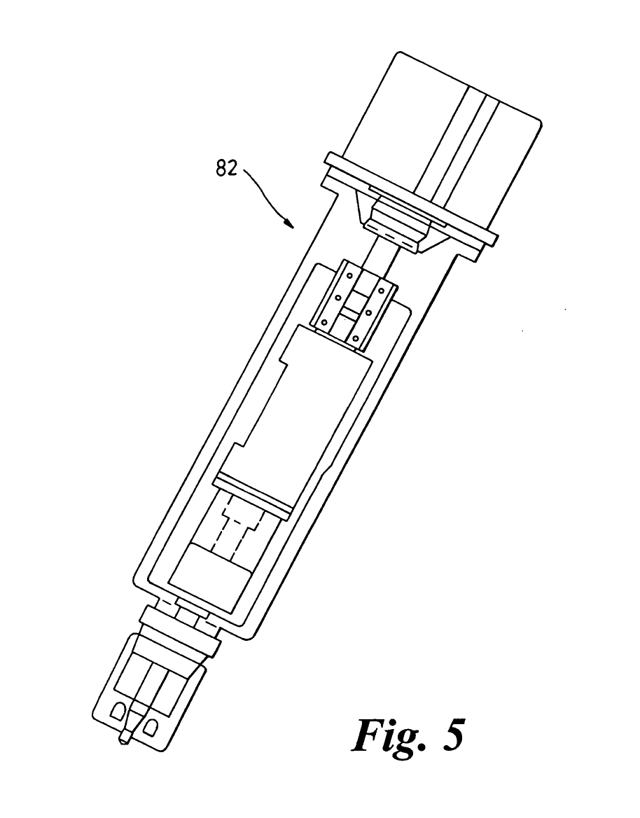

FIG. 5 is a schematic perspective view of a drill tool which could be used with the end-effector of FIG. 2;

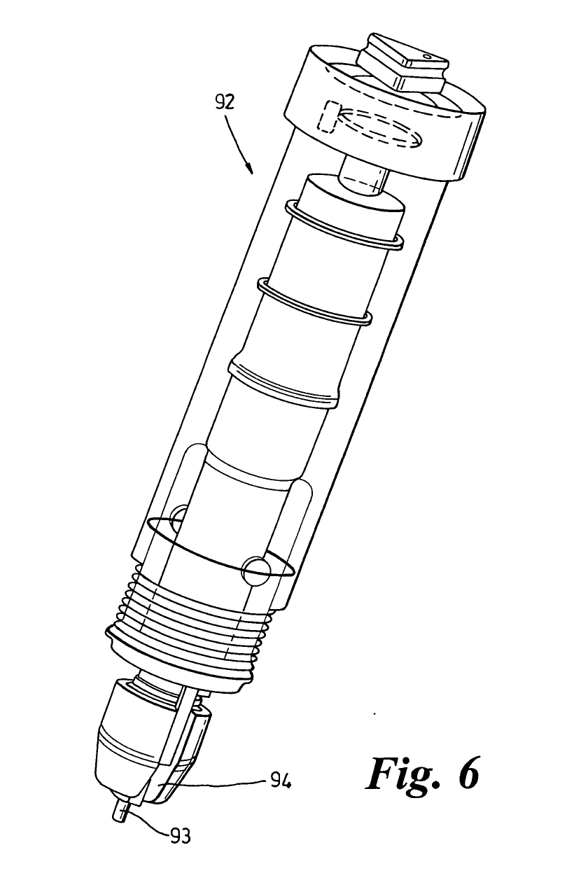

FIG. 6 is a schematic perspective view of a riveting tool which could be used with the end-effector of FIG. 2;

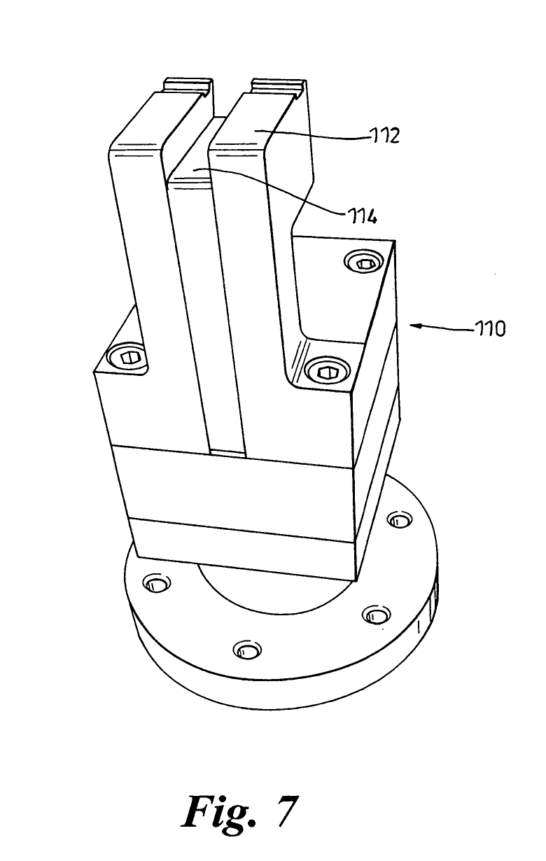

FIG. 7 is a view of the lower end-effector or ‘bucking bar’ of FIG. 1.

One embodiment of an automated riveting machine according to the present invention is illustrated in FIG. 1 of the accompanying drawings. The machine comprises two end-effectors, an upper end-effector 11 and a lower end-effector 12, mounted upon robots 18, located at workstations on opposite sides of a workpiece 14. The workpiece 14 comprises two pieces 15 and 16 which are to be riveted together.

The end-effectors 11 and 12 are both lightweight and are carried on separate, compact robots 18, such as the NEOS Tricept™ robot, however any suitable robot could be used.

In this embodiment, the upper end-effector 11 functions as a drilling, sealant dispensing and riveting tool, and is described in more detail with reference to FIGS. 2 to 6 of the accompanying drawings. The lower end-effector 12, described in more detail in FIG. 7, is positioned behind the workpiece 14, in line with the upper end-effector 11, and provides clamping during drilling and counter sinking operations and acts as ‘bucking bar’ during the rivet upsetting operation. The opposing forces applied by each end-effector helps to hold the end-effector in position.

FIG. 2 to 6 show details of the upper end-effector assembly 20.

The upper end-effector 20 comprises three tools, a drilling tool (not visible in this view), a sealant dispensing tool (also not visible in this view), and a riveting tool 22. Each tool is used sequentially to rivet a workpiece. Initially a hole is drilled in the workpiece, sealant is then placed into the hole to ensure that the rivet connection will be airtight, allowing the structure to be pressurised, and finally a rivet is placed in the hole and the stem upset to fix the rivet in place.

Each tool is located in a carrier arm. Although only two carrier arms 23 and 24 are visible in the view in FIG. 2 three arms are present, each carrying a respective one of the three tools. Carrier arm 23 is depicted with the riveting tool 22 located therein. Each carrier arm has two bores 26 and 27. Bore 26 allows the carrier arm 23 to be located on a cage structure support member 39 (FIG. 2) of the upper end-effector 20. The other bore 27 accommodates the tool, in this case the riveting tool 22.

FIG. 3 is a schematic perspective view of the cage structure 30 of the upper end-effector 20. The cage structure 30 is a rigid frame comprising an upper end plate 32 and a lower end plate 33 held in a fixed spaced relationship by three cylindrical support members 37, 38 and 39. In the complete upper end-effector 20 (depicted in FIG. 2), the tool carrier arms 23 and 24 are mounted upon, and can pivot about, the support members 37, 38 and 39.

The support members 37, 38 and 39 are radially spaced around a datum point comprising a central guide hole 40 in the lower end plate 33. The guide hole 40 serves as a fixed datum within the upper end-effector 20 in which each working head or tool can be sequentially placed and operated. This removes the need for high levels of repeatability in tool positioning and alignment from the robot 18 once the upper end-effector 20 has been positioned at the workpiece.

Once the upper end-effector 20 is positioned at the workpiece, the drilling, sealing and riveting functions are all performed without moving the upper end-effector 20, each tool operating in turn though the fixed datum guide hole 40. Each tool is located in a carrier arm 23, 24, which is pivoted about its respective support 39, 37 to locate the tool above the guide hole 40 as needed.

The pivoting of the carrier arms 23, 24 is facilitated by pneumatic cylinders and rams. For example, carrier arm 24 is pivoted about support 37 by expansion and retraction of the ram in pneumatic cylinder 44, which is fixed to the end plate 33 at one end and to the carrier arm 24 at the other. In the retracted position the tool is located in a resting position, toward the outer edge of lower end plate 33, and in the extended position, the operating position, the tool is located above the guide hole 40.

Once a tool 22 is located above the guide hole 40 the feed mechanism, illustrated in FIG. 4, operates to move the tool 22 towards the workpiece.

The feed mechanism comprises a plate 57 suspended from which are three 30 52, 53 and 54 pneumatic cylinders and rams, which operate to lower and raise the plate 57. In the complete upper end-effector 20 illustrated in

FIG. 2 the pneumatic rams and cylinders 53, 54 are shown connected to the lower end plate 33. The plate 57 is shaped with cut out portions 62, 63, and 64 configured to locate around and move past the support members 37, 38 and 39 of the cage structure 30. Further cut out portions 66, 67 and 68 in plate 57 are configured to locate around and move past tools in the resting position. When a tool is located above the guide hole 40 (not illustrated) ready for use, the pneumatic cylinders 52, 53 and 54 will be operated to retract the ram and lower the plate 57. The central hole 71 of the plate 57 contacts and captures the tool 22, about a projection 35 on the uppermost end, and depresses it somewhat towards the workpiece. The extent of movement of the tool towards the workpiece depends on the nature of the tool and the function it has to perform.

Each tool is self-contained, requiring only services and control signals from the upper end-effector. The tools can be readily removed for maintenance, repair or exchange, say, to accommodate different types or sizes of fastener.

FIG. 5 illustrates a tool configured as a drill 82, which can be located in the bore of any carrier arm, such as 23 or 24. The drill unit is controlled by an internal drive, and is not driven by the robot 18.

Exhaust from the air motor of the drill is diverted to immediately remove the swarf produced by drilling, eliminating the need for a separate air feed specifically for this function.

FIG. 6 illustrates a tool configured as a riveting tool 92. Again this tool an be located in any carrier arm. Rivets 93 are gripped by jaws 94 and placed in a drilled hole in the work piece. The jaws 94 are then opened to release the rivet 93. Once in position a vibration using pneumatics is applied to upset the rivet against the lower end-effector 12 or bucking bar located on the other side of the workpiece (FIG. 1).

The upper-end-effector 20 also contains an advanced monitoring system to allow instant detection of any process failures before damage occurs to the workpiece and to maintain overall machine quality control. Indeed, camera inspection of the process allows hole quality, the drill end and rivet placement to be monitored. The camera may be located in the sealant dispensing tool. Each rivet can be checked for quality and a process conformity report supplied. Sensors can be positioned at all steps and if set criteria are not met the machine will stop.

A load cell 101, 100 is located at the interface between the upper end-effector 11, 20 and the robot 18 (FIGS. 1 and 2). The load cell is a pressure-monitoring device comprising a piezo ceramic cell which monitors and controls pressure exerted upon it. The load cell effects the movement of the upper end-effector 11 and the lower end-effector 12 towards or away from the workpiece 14 as necessary. The load required depending upon the stage of the riveting cycle. For example, when drilling a higher force is required to minimise burring and the upper and lower end-effectors essentially clamp the workpiece. When a rivet is inserted into the drilled hole the force is relaxed.

FIG. 7 illustrates the lower end-effector 110 which is considerably simpler than the upper-end-effector 20 (FIG. 2), having a clamping foot 112 and moveable reactor 114 for upsetting the rivet stem. The main purpose of the lower end-effector 110 is to provide a reactive force for the upper end-effector 20 situated on the opposite side of the workpiece 14.

The geometry of the clamp foot is designed to accommodate the maximum possible number of frame/stringer geometries. There may be occasions however, where lower end-effectors with ‘special to type’geometries will be required.

Ideally, the control system for the automatic riveting machine uses an industrial PC, which supports both the control of the end-effectors and communication with the robot. Indeed the lower end-effector robot may be slaved to the upper end-effector robot, such that the lower end-effector automatically moves in response to movement of the upper end-effector.

Whilst in the above embodiment tools configured as a drill, sealant dispenser and riveter have been considered, in practice any suitable tool or the working head could be any tool, such as a screwdriver or a self piercing riveting device, depending on the intended task to be performed.

1. A tool support, adapted in use to define an end-effector of an automated riveting machine, comprising at least two tool carrier arms, one of which is adapted to support a riveting tool, in which the tool carrier arms are movable relative to a fixed datum defined by the tool support.

2. A tool support as claimed in claim 1 in which the fixed datum is configured as a guide hole.

3. A tool support as claimed in any of the preceding claims in which one or more support members hold opposing ends of the tool support in a fixed spaced relationship.

4. A tool support as claimed in claim 3 in which opposing ends of the tool support are configured as end plates.

5. A tool support as claimed in claim 4 in which the guide hole is located in the end plate which is positioned closest to a workpiece when in use.

6. A tool support as claimed in any of claims 3 to 5 in which the support members are spaced around the guide hole.

7. A tool support as claimed in any of the preceding claims in which the carrier arm includes one or more bores.

8. A tool support as claimed in claim 7 in which a first bore in the carrier is used to mount the carrier arm on a support member, and a second bore in the carrier arm may accommodate a tool.

9. A tool support as claimed in claim 8 in which the carrier arm is movable to locate the second bore over the guide hole.

10. A tool support as claimed in any of claims 7 to 9 in which the carrier arm can pivot about the support member upon which it is mounted.

11. A tool support as claimed in any of the preceding claims in which the carrier arm is moveable by a ram and cylinder assembly.

12. A tool support as claimed in any of the preceding claims including a feed mechanism adapted to extend and retract a tool, accommodated in a carrier arm, into and out of the guide hole.

13. A tool support as claimed in claim 12 in which the feed mechanism comprises a plate suspended from a cylinder and ram assembly adapted to raise and lower the plate.

14. A tool support as claimed in claim 12 or claim 13 in which, the feed mechanism is adapted to capture a tool accommodated in a carrier arm.

15. An end-effector for an automated riveting machine comprising a drilling tool, a sealant dispensing tool and a riveting tool.

16. An end-effector as claimed in claim 15 provided with a fixed datum with respect to which the tools are movable.

17. An end-effector as claimed in claim 16 in which the fixed datum is configured as a guide hole.

18. An end-effector as claimed in claim 17 in which the tools are configured to operate through the guide hole

19. An end-effector as claimed in claim 17 or claim 18 in which the guide hole is located in the end of the end-effector which in use is positioned closest to a workpiece.

20. An end-effector as claimed in any of claims 15 to 19 in which the tools are movable between a resting position and an operating position.

21. An end-effector as claimed in any of claims 15 to 20 in which a tool is accommodated in a movable carrier arm.

22. An end-effector as claimed in any of claims 15 to 21 which includes three movable carrier arms, each carrier arm accommodating one tool.

23. An end-effector as claimed in any of claim 21 or claim 22 in which the carrier arm is mounted on a support member.

24. An end-effector as claimed in claim 23 in which the carrier arm can pivot about the support member upon which it is mounted.

25. An end-effector as claimed in any of claims 21 to 24 in which a cylinder and ram assembly moves the carrier arm.

26. An end-effector as claimed in any of claims 21 to 25 in which a carrier arm includes one or more bores.

27. An end-effector as claimed in claim 26 in which a first bore is used to mount the carrier arm on the support member and a second bore may accommodate a tool.

28. An end-effector as claimed in any of claims 17 to 27 which includes a feed mechanism adapted to extend a tool into the guide hole.

29. An end-effector as claimed in any of claims 17 to 28 in which includes a feed mechanism adapted to retract a tool from the guide hole.

30. An end-effector as claimed in any of claims 15 to 29 including a load cell

31. An end-effector as claimed in claim 30 in which the load cell is located on the end-effector at the interface with a robot.

32. An end-effector as claimed in claim 30 or claim 31 in which the load cell comprises a piezo ceramic cell.

33. An end-effector as claimed in any of claims 15 to 33 including a tool support as claimed in any of claims 1 to 14.

34. An automated riveting machine comprising a first end-effector and a second end-effector, the first end-effector carrying the tools, the second end-effector being positioned on the opposite side of a workpiece to, and in-line with, the first end-effector.

35. A machine as claimed in claim 34 in which the second end-effector comprises a clamping foot for clamping the workpiece.

36. A machine as claimed in either claim 34 or claim 35 in which the second end-effector comprises a moveable reactor for upsetting a rivet stem.

37. A machine as claimed in any of claims 34 to 36 including a first end-effector according to any of claims 15 to 33.

38. A method of achieving a rivet connection in a workpiece comprising locating a first end-effector, with at least two tools one of which is a riveting tool, at a workpiece and positioning a second end-effector at the opposite side of the workpiece in-line with the first end-effector; sequentially moving each tool, in the first end-effector, arcuately from a resting position to an operating position above a guide hole in a lower end plate of the first end-effector, and operating each tool in turn through the guide hole to perform their desired operation.

39. A method as claimed in claim 38 in which a tool is configured as a sealant dispensing tool.

40. A method as claimed in claim 38 or claim 39 in which a tool is configured as a drill tool.
